(19) United States
(12) Patent Application Publication
(10) Pub. No.: US 2024/0281651 A1
(43) Pub. Date: Aug. 22, 2024

(54) APPARATUS AND METHOD FOR DEEP SEGMENTAL DENOISING NEURAL NETWORK FOR SEISMIC DATA

(71) Applicant: KING FAHD UNIVERSITY OF PETROLEUM AND MINERALS, Dhahran (SA)

(72) Inventor: Naveed IQBAL, Dhahran (SA)

(73) Assignee: KING FAHD UNIVERSITY OF PETROLEUM AND MINERALS, Dhahran (SA)

(21) Appl. No.: 18/171,551

(22) Filed: Feb. 20, 2023

(51) Int. Cl. G06N 3/08

(52) U.S. Cl. CPC G06N 3/08

(57) ABSTRACT

An apparatus, computer readable storage medium, and method for deep segmental denoising neural network for microseismic data is described. The apparatus includes a seismic data recording network with geophones each having a seismic data receiver and configured to record microseismic waves as a seismic trace received from a geological formation, a preprocessing stage and a deep neural network. The preprocessing stage transforms the recorded signal trace to a time-frequency representation as real number values. The deep neural network generates a denoised signal from the time-frequency representation. The deep neural network is trained based on a segment of noisy spectra and a clean spectra segment to learn a mapping function that generates the segment of the denoised microseismic signal.

### STATEMENT REGARDING PRIOR DISCLOSURE BY THE INVENTORS

Aspects of this technology are described in an article N. Iqbal, “DeepSeg: Deep Segmental Denoising Neural Network for Seismic Data,” in IEEE Transactions on Neural Networks and Learning Systems, 2022, doi: 10.1109/TNNLS.2022.3205421, incorporated by reference in its entirety.

### BACKGROUND

### Technical Field

The present disclosure is directed to seismic signal recovery from a noisy signal, and in particular to apparatus and method for deep segmental denoising neural network for seismic data.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In oil and gas exploration, a seismic survey is an important tool for exploring subsurface mineral deposits, volcanic monitoring, landslide monitoring, monitoring of glaciers, and underground tomography. The seismic survey is performed by sending seismic waves into the deep subsurface of the Earth and recording the reflected and refracted waves. The recording is performed by receiver devices such as geophones.

Microseismic monitoring is an important tool for monitoring fluid flow and pressure/stress changes in the subsurface during fluid injection and extraction, especially during hydraulic fracturing for enhanced hydrocarbon production and geothermal energy production. In general, the seismic waves generated by microseismic events are recorded with geophone arrays at or near the earth's surface and in boreholes. Because the exact source-excitation times of microseismic events cannot be predicted, ground motion is measured continuously to try to detect microseismic waveforms in the continuous recorded data.

In some cases, microseismic events have source locations, and the (x, y, z) spatial location (hypocenter) and the source time t0 for each event are determined. In these cases, the microseismic-event locations provide information about the region of fluid flow, pressure change, and rock fracturing.

A microseismic event is defined as an earthquake and/or subterranean disturbance that is not “felt” by the public, which usually implies an earthquake with a “moment magnitude” Mw less than about 3 or 4. Mw is a common measure of an earthquake's strength and is a dimensionless quantity.

However, the recorded waves or signals are heavily contaminated by noise and other signals due to the earth's ambient passive response as a consequence of natural phenomena, such as ocean waves, wind, or human activities such as traffic, electrical noise, machine noises, and other man-made noises. Conventional techniques to filter the noise from the signal use bandpass or spectral filtering in seismic signal processing. These filtering techniques effectively remove random wide-band noise like white noise or other suppressing noise with strong energy outside the band of the signal of interest. However, the filtering techniques fail when the noise occupies the same band as the seismic signals. To deal with noise that occupies the same band as the seismic signals, conventional spatial prediction filters have been used. However, specification of suitable filtering parameters for the spatial prediction filters generally vary with situation/time, which is a non-intuitive process and substantially alters the seismic signal which further degrades the subsequent seismic data analysis.

Due to these constraints, many attempts have been made to establish more effective noise reduction techniques for seismic data. These conventional noise reduction techniques are focused on time-frequency based denoising processing techniques. In these techniques, time-domain noisy signals are transformed to the 2D time-frequency domain representation using a transformation, such as short-time Fourier transform, curvelet transform, wavelet transform, S-transform, empirical mode decomposition, dreamlet transform, or W-transform. The time-frequency representation of the noisy signal is manipulated in such a way as to attenuate the noise-related coefficients while keeping or enhancing the signal-related coefficients. The attenuation is normally done using a thresholding technique. To reconstruct the denoised seismic signal, the modified time-frequency representation is inverse-transformed back into the time-domain. The aforementioned technique requires optimal threshold function. A conventional denoising technique using a threshold function was described (See: W. Zhu, S. M. Mousavi, and G. C. Beroza, “Seismic signal denoising and decomposition using deep neural networks,” IEEE Trans. Geosci. Remote Sens., vol. 57, no. 11, pp. 9476-9488, November 2019, incorporated herein by reference in its entirety). An improper threshold function can cause either signal attenuation or ineffective noise suppression. In other words, finding the optimal thresholding function to separate signal from noise is challenging. In another conventional technique, transforming a noisy signal into another domain has been tried when there is frequency content overlap between noise and signal of interest. The transformation promotes sparsity so that the signal of interest can be represented by sparse features and easily distinguished from the noise. These transformation-based denoising methods can suppress noise that occupies the same frequency bands as the signal. A more effective sparse representation, rather than just thresholding, may improve the performance of time-frequency domain denoising methods. However, the transformation-based denoising methods have not been very effective.

Accordingly, it is one object of the present disclosure to provide a signal denoising neural network apparatus and a method for effectively denoising seismic data, especially microseismic data.

### SUMMARY

An aspect of the present disclosure is an apparatus for denoising a microseismic signal, is described. The apparatus includes a seismic data recording network including a plurality of geophones each having a seismic data receiver and configured to record a plurality of microseismic waves as a signal trace received from a geological formation, wherein the plurality of geophones is communicatively coupled with a seismic data processor. The seismic data processor has a preprocessing stage and a deep neural network. The preprocessing stage transforms the recorded signal trace to a time-frequency representation as real number values. The deep neural network generates a denoised signal from the time-frequency representation. The deep neural network is trained using a segment of noisy spectra and a clean spectra segment to learn a mapping function that generates the segment of denoised microseismic signal.

In the aspect, the preprocessing stage receives a signal trace and applies a sequence of discrete cosine transforms (STDCT) on windowed sections, by sliding the window location across the entire recorded signal trace and applying DCT on each windowed section, to obtain N segments of a noisy spectra of the signal trace in the time frequency domain.

In the aspect, the deep neural network is a deep convolutional neural network having a cascade of convolutional layers with descending followed by ascending sizes, where the last layer is a fully connected layer.

The input to the deep neural network is 15 noisy segments and the output is a cleaned middle segment.

The convolutional layers with ascending sizes are transposed convolutional layers.

The segment of noisy spectra for training includes a past noisy spectra, future noisy spectra, and current noisy spectra.

The deep neural network is trained based on a loss function of:

$$𝔼 ( ϕ ) = \frac{1}{128} {\sum }_{q = 1}^{128} {\frac{1}{2} [ t ( q ) - p ( q ) ]}^{2} ,$$

where p(q) and t(q) are the q^{th} element of network prediction and target output, respectively, and φ represents the parameters of the deep neural network.

A seismic source is configured to propagate an initial seismic wave at or above the geological formation.

A further aspect of the present disclosure is a non-transitory computer readable storage medium storing program instructions, which when executed by processing circuitry, performs a method including recording, by a seismic data recording network comprising a plurality of geophones, a plurality of microseismic waves as a signal trace received from a geological formation; transforming, in a preprocessing stage, the recorded signal trace to a time-frequency representation as real number values; and generating, by a learned deep neural network, a denoised signal from the time-frequency representation, wherein the learned deep neural network is trained using a segment of noisy spectra and a clean spectra segment to learn a mapping function that generates the segment of denoised microseismic signal.

A further aspect of the present disclosure is a method of signal denoising, including recording, by a seismic data recording network comprising a plurality of geophones, a plurality of microseismic waves as a signal trace received from a geological formation; transforming, in a preprocessing stage, the recorded signal trace to a time-frequency representation as real number values; and generating, by a learned deep neural network, a denoised signal from the time-frequency representation, wherein the learned deep neural network is trained using a segment of noisy spectra and a clean spectra segment to learn a mapping function that generates the segment of the denoised microseismic signal.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 depicts a geological environment for seismic data detection, according to aspects of the present disclosure;

FIG. 2 depicts a general block diagram illustrating functional components of a seismic activity detection system, according to aspects of the present disclosure;

FIG. 3 illustrates a system for a signal denoising neural network, according to aspects of the present disclosure;

FIG. 4 is a schematic diagram of a deep neural network, according to aspects of the present disclosure;

FIG. 5 illustrates the deep neural network for signal-to-noise ratio (SNR) enhancement, according to aspects of the present disclosure;

FIG. 6A-FIG. 6C show different noise signals, FIG. 6C-FIG. 6F show spectrum corresponding to the noise signals of FIG. 6A-FIG. 6C, FIG. 6G-FIG. 6I illustrate spectrogram corresponding noise signals of FIG. 6A-FIG. 6C and FIG. 6G-FIG. 6L illustrate correlation plot corresponding noise signals of FIG. 6A-FIG. 6C, according to aspects of the present disclosure;

FIG. 7A-FIG. 7I illustrate examples demonstrating denoising of synthetic data, according to aspects of the present disclosure;

FIG. 8 is an exemplary plot illustrating a comparison of signal to noise ratio (SNR) obtained by the deep neural network of the disclosure and a conventional neural network, according to aspects of the present disclosure;

FIG. 9 is an exemplary plot illustrating trace-by-trace comparison to evaluate capabilities and strength of the deep neural network with the conventional neural network, according to aspects of the present disclosure;

FIG. 10A illustrates a plot indicating a number of traces used for training a conventional neural network, according to certain embodiments.

FIG. 10B illustrates a plot indicating a number of traces used for deep neural network of present disclosure, according to aspects of the present disclosure;

FIG. 11A-FIG. 11F illustrate examples of denoising real seismograms, according to aspects of the present disclosure;

FIG. 12 is an illustration of a non-limiting example of details of computing hardware used in the computing system, according to aspects of the present disclosure;

FIG. 13 is an exemplary schematic diagram of a data processing system used within the computing system, according to aspects of the present disclosure;

FIG. 14 is an exemplary schematic diagram of a processor used with the computing system, according to aspects of the present disclosure; and

FIG. 15 is an illustration of a non-limiting example of distributed components that can share processing with the controller, according to aspects of the present disclosure.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

This disclosure is directed to an apparatus and method for deep segmental denoising neural network for seismic data. The apparatus and method described herein include time-frequency transformation and deep learning through a deep neural network. The deep neural network is configured to learn a sparse representation of the 2D input data as well as a high-dimensional non-linear function that creates desired a time-frequency domain representation from a noisy 2D time-frequency domain training data set. When a time-frequency representation (a 2D matrix) is provided, the deep neural network of the disclosure produces a present instant segment (transform domain windowed section of the data) using past, present, and future instant segments of the time-frequency representation. Experiments were performed by tampering synthetic waveforms and synthetic earthquake seismograms with various types of synthetic noise for network training and performance demonstration. The apparatus and method of the current disclosure were tested on unseen noisy seismograms in order to illustrate its generalization, to record its ability to enhance passive seismic detection/denoising results, and to compare its performance with the conventional deep learning-based denoising techniques.

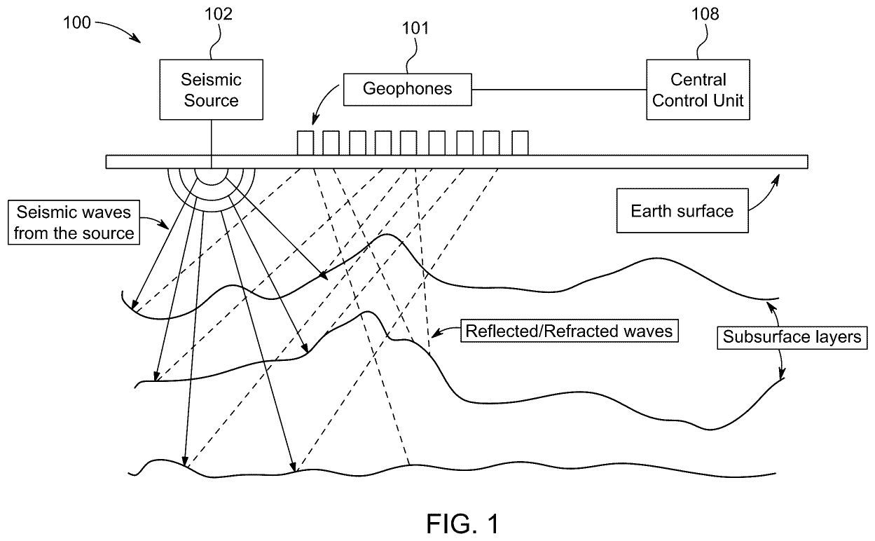

FIG. 1 depicts a geological environment 100 for seismic data detection, in accordance with an exemplary embodiment. The geological environment 100 may include, but may not be limited to, a seismic source 102, an array of geophones 101, and a central control unit 108. In one implementation, the seismic source 102 may be configured to transmit, in a controlled environment, seismoelectric waves towards the Earth's surface and subsurface layers. For example, the seismic source 102 might be dynamite or a seismic vibrator that creates a seismic wave that propagates into the subsurface. The seismic wave, in one example, may be an acoustic wave. The produced seismic wave propagates at the surface and subsurface layers of the Earth, and then, is partially reflected towards the surface by seismic reflectors. The seismic reflectors can be interfaces between subsurfaces characterized by different elastic properties. The reflected signals are then detected and recorded by seismic receivers located at or near the surface of the Earth. In one implementation, the array of the geophones 101 may be implemented on or near the surface to receive the reflected seismic waves. The array of the geophone, thereby, may generate electric signals corresponding to the reflected seismic wave indicating the subsurface formation, positions, and activities. The electrical signal may be embedded with information regarding the subsurface and captured as a record of seismic data.

According to one embodiment, the array of the geophones 101 may be implemented as such to create a dense field of sensors. In one example, the array of the geophones may be implemented as a vertical component of geophones 101. In another example, the array of the geophones may be implemented as horizontally aligned geophones 101. In a still further implementation the geophones are implemented as a cone such that the geophone at the apex of the cone is the deepest buried geophone which is surrounded by consecutively expanding circles of geophones with each successive geophone at a depth in the earth less than the depth of a predecessor circle until the last circle is on the surface of the Earth. In another implementation, the sensor devices may be hydrophones or accelerometers, or a combination thereof.

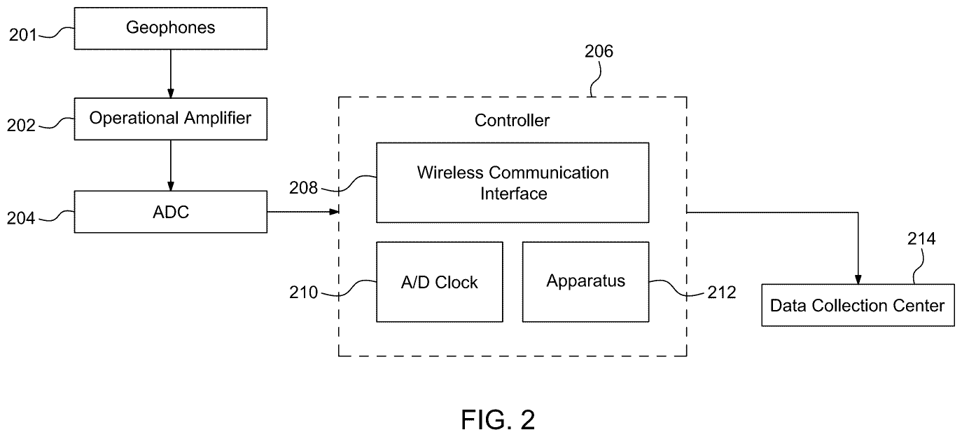

The data gathered by sensor devices and the array of geophones 101 may be collected by a central control unit 108. The central control unit 108 may be configured to perform analysis or other data processing required for wireless data transmission. The central control unit 108, in one implementation, may be controlled by a controller 206 (shown in FIG. 2). The controller 206 may include a set of executable commands, which upon execution, can control the operations of the central control unit 108. In one implementation, the data collected by the sensors and the array of geophones 101 may be used alone or in combination with other data. The data may be collected in one or more databases and/or transmitted to a data collection center 214 (shown in FIG. 2). The data may be historical data, real-time data, or combinations thereof. The real-time data may be used in real-time, or stored for later use. The data may also be combined with historical data or other inputs for further analysis. The data may be stored in separate databases, or combined into a single database.

FIG. 2 depicts a general block diagram illustrating functional components of a seismic activity detection system, according to one embodiment. The geophones 101 as sensor devices are described in reference to FIG. 1. The array of geophones 201, is an array of the sensor devices implemented to gather seismic data in a similar way as that of geophones 101. The geophones 201 can collect seismic waves, and convert the seismic waves into an electrical signal. The electrical signal may be converted into a digital signal. The seismic digital signal may be transmitted to a controller 206 for analysis and signal processing. The controller 206 may include an apparatus 212, configured for mitigating wireless data transmission impairments and enhancing the signal. The enhanced signal may be transmitted to a data collection center 214 through a wireless communication unit. Details of each functional component are described in subsequent paragraphs.

In one implementation, the array of the geophones 201 is configured to receive reflected/refracted seismic data in analog form. The amplitude of the analog signal, corresponding to the received seismic data, is amplified by an operational amplifier 202, in one implementation. The operational amplifier 202 is a well-known component in the art, therefore, a detailed description of the operational amplifier 202 is not provided in this disclosure for the sake of brevity. The amplified analog signal may be converted into a digital signal by an analog-to-digital converter (ADC) 204, in accordance with one implementation. The digital signal generated by the ADC 204 is a digital representation of the recorded analog seismic data.

In one implementation, the digital signal may be fed to the controller 206 for digital signal processing. The controller 206 may include, but may not be limited to a wireless communication interface 208, an analog-to-digital clock 210, and an apparatus 212.

The wireless communication interface 208 may be configured to perform at least one of receiving the first signal or transmitting a second signal to the wireless communication unit in an implementation. In one example, the wireless communication interface 208 is configured to receive the first signal, e.g., a digital signal corresponding to a seismic wave, from ADC 204. In another example, the wireless communication interface 208 is configured to transmit the second signal, e.g. a digitally processed and enhanced first signal, to the data collection center 214. A wireless communication network, a wireless communication protocol, and/or parameters of wireless communication protocol may be selected in accordance with specific applications and requirements.

The wireless communication interface 208 may receive the first signal from the ADC 204 at the rate of the sampling frequency of the ADC 204. In one implementation, the A/D clock 210 may be configured to synchronize the digital signal reception in accordance with the sampling frequency of the ADC 204.

The apparatus 212, in one implementation, may be configured to denoise wireless data transmission in the digital signal using a deep neural network. The apparatus 212 is discussed in more detail with reference to subsequent figures. The apparatus 212 is capable of denoising and enhancing the signal-to-noise ratio (SNR) prior to signal transmission to the data collection center 214.

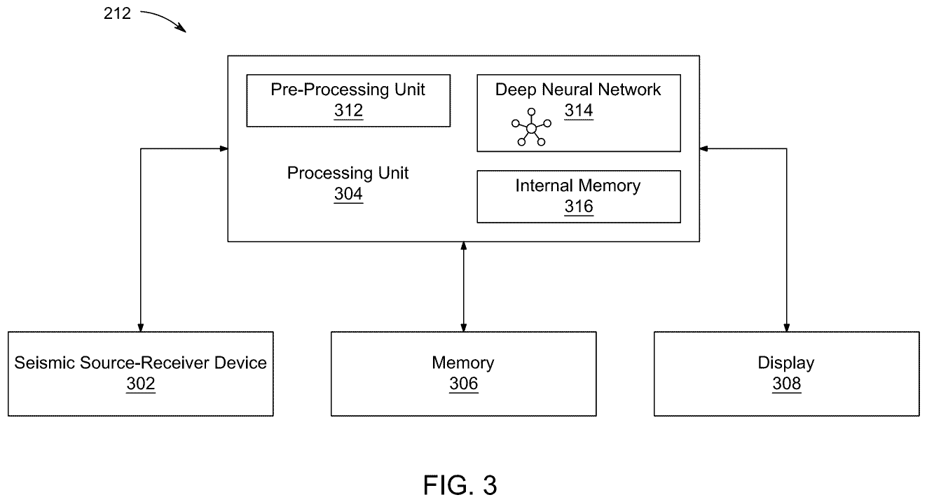

FIG. 3 illustrates an apparatus for a signal denoising neural network, according to an embodiment of the present disclosure. The apparatus 212 can receive an input from a seismic source/receiver device 302, and can output the processed data to the memory 306 and/or the display 308. The seismic source/receiver device 302 may be implemented to receive at least one signal, for example, the first signal, from the wireless communication interface 208, as described in FIG. 2.

The seismic source/receiver device 302 can include a seismic source device 102 that generates and transmits seismic waves into deep subsurface of the Earth, and a receiver that receives reflected and refracted seismic waves. In one example implementation, the seismic source device 102 and the receiver of the seismic source/receiver device 302 can be implemented as a single unit. In another example implementation, the seismic source device 102 and the receiver can be implemented as separate units. In an example, the receiver is an array of geophones 101. In another example, the receiver is a hydrophone.

The apparatus 212 can include, among other things, a processing unit 304. According to an embodiment, the processing unit 304 can be a single processing unit or more than one processing unit. The processing unit 304 can be implemented as one or more microprocessors, microcomputers, digital signal processors, central processing units, state machines, logic circuitries, and/or any devices that manipulate signals based on operational instructions. Among other capabilities, the processing unit 304 can be configured to fetch and execute computer-readable instructions stored in the memory 306. Functions of the various elements shown in FIG. 3A, including functional blocks labeled as “processing unit 304”, can be provided through the use of dedicated hardware as well as hardware capable of executing software. The processor can be embodied as a single dedicated processor, a single shared processor, a plurality of individual processors among which a few can be shared or a machine having a multi-core GPU, e.g. Nvidia Titan GPU with 6 GB of video RAM. Moreover, explicit use of the term “processing unit” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage, or any other hardware known to a person skilled in the art.

The memory 306 can be coupled to the processing unit 304 and configured to support the processing unit 304 in data and memory operations. The memory 306 can include any computer-readable medium known in the art including, for example, volatile memory, such as Static Random Access Memory (SRAM) and Dynamic Random Access Memory (DRAM), and/or non-volatile memory, such as Read Only Memory (ROM), Erasable Programmable ROMs (EPROMs), flash memories, hard disks, optical disks, and magnetic tapes, or any other memory known to the person skilled in the art. The display 308 is used for displaying data recorded seismic data, the denoised signal and other information.

The processing unit 304 is configured to process the reflected and the refracted seismic waves to eliminate noise signals and to output a denoised signal. The processing unit 304 includes a pre-processing unit 312, a deep neural network 314 and an internal memory 316. The pre-processing unit 312 processes and transforms the reflected and the refracted seismic waves into signal traces having seismic data. The pre-processing unit 312 transforms the signal traces to time-frequency representation (also referred to as 2D). In example, the pre-processing unit 312 uses a short-time Fourier transform to perform the transform operation. Using the short-time Fourier transform can involve the processing of complex numbers. In some examples, the pre-processing unit 312 can use a neural network to perform the transform operation. The neural network can function effectively with real numbers for the transformation. In some examples while using the neural networks, real and imaginary parts of the signal traces can be separately input to a deep neural network unit (not shown) as two channels. In some examples, the real and imaginary parts can be used in a single channel. In an aspect, using the real number enhances a prediction performance of the processing unit 304. Also, the use of real numbers provides flexibility in terms of configuration of neural networks. In order to have the real values, the pre-processing unit 312 can use a discrete cosine transform. In an example, the pre-processing unit 312 uses a short-time discrete cosine transform (STDCT). The STDCT is a sequence of discrete cosine transforms. The pre-processing unit 312 applies the STDCT on windowed sections of the signal traces by sliding the window location across the entire signal and applying DCT on a windowed section of the data (referred to as a segment). For a signal s of size N, the DCT is defined as follows:

$$x ( k ) = \sqrt{\frac{2}{N}} {\sum }_{n = 1}^{N} s ( n ) cos ( \frac{π}{4 N} ( 2 n - 1 ) ( 2 k - 1 ) ) , \qquad ( 1 )$$

$$k = 1 , … , N$$

To identify the inverse, k and n are switched in the above definition. The pre-processing unit 312 transforms the signal traces to the time-frequency domain representation using the STDCT, with for example, a rectangular window of size N=128 samples and an overlap of 90%. Using the STDCT, the pre-processing unit 312 obtains N segments of noisy spectra of the signal trace in the time-frequency domain. The pre-processing unit 312 uses the noisy spectra to obtain clean spectra using the deep neural network 314. In an example, in order to recover the time-domain trace, an inverse short-time Fourier transform can be used.

The deep neural network 314 denoises the data, and outputs a denoised signal from the time-frequency representation. In an example, the deep neural network 314 is implemented on the processing unit 304 having a multi-core GPU, such as, Nvidia Titan GPU with 6 GB of video RAM or on a special purpose processor such as a multi-core GPU or machine learning engine (see M series processors by Apple). These special purpose processors can be provided in a cloud service, or in an AI workstation. The M-series processors (System on a Module, SoM) of Apple are currently the processor in MacBook pro computers. The tool kits being used for these special purpose processors include TensorFlow and PyTorch. In some examples, the processing unit 304 can be a machine learning processor.

The deep neural network 314 is trained based on a segment of noisy spectra and a clean spectra segment to learn a mapping function that generates the segment of denoised spectra. The segment of noisy spectra for training can include a past noisy spectra, future noisy spectra, and current noisy spectra. The denoising aspect is described herein in detail. In an aspect, the denoising problem is rendered as a supervised deep learning where the deep neural network 314 is configured to learn a sparse representation of the seismic signal/waveform using training samples that are obtained from noisy signal distribution.

In the time-frequency domain representation, the received/recorded data is referred to as Y, is represented as the superposition of the seismic waveform, X, and some additive instrumental/natural noise or other non-seismic signals conjointly referred to as noise, N, that is:

$$Y = X + N . \qquad ( 2 )$$

The deep neural network 314 performs denoising to infer an underlying signal of interest, \hat{X}, that is, the denoised signal from its version contaminated by noise. Instead of using the entire spectra of a trace, the deep neural network 314 uses segments. Using segments results in less training data and a more stable neural network, leading to favorable results on unseen data.

Given a segment of noisy spectra {Yₙ}ₙ₌₁^{T}, and clean spectra {Xₙ}ₙ₌₁^{T}, the deep neural network 314 aims to learn a mapping function ƒ that generates a segment of denoised spectra {ƒ(Yₙ)}ₙ₌₁^{T}, that is:

$$min {\sum }_{t = 1}^{T} {‖ {X}_{n} - f ( {Y}_{n} ) ‖}_{2}^{2} . \qquad ( 3 )$$

Specifically, the mapping function ƒ is learned using the deep neural network 314. In order to enhance the performance, the objective function (3) is modified to use past bΔ/2c noisy spectra {Yᵢ}_{i=n-[Δ/2]}ⁿ, future bΔ/2c noisy spectra {Yᵢ}ᵢ₌ₙ^{n+[Δ/2]} and current noisy spectra Yₙ to denoise the current spectra Yₙ, that is:

$$min {\sum }_{n = 1}^{T} {‖ {X}_{n} - f ( {Y}_{n - ⌊ Δ / 2 ⌋} , … , {Y}_{n - ⌊ Δ / 2 ⌋} ) ‖}_{2}^{2} . \qquad ( 4 )$$

The value of Δ is set to 15 segments, which can be obtained empirically using sensitivity analysis. The noisy spectra are zero-padded for n=1 and n=T. The aforementioned approach to configuring the deep neural network 314 is analogous to filter design in digital signal processing and has been found to be more effective than merely having a neural network that maps input to output to perform the denoising task.

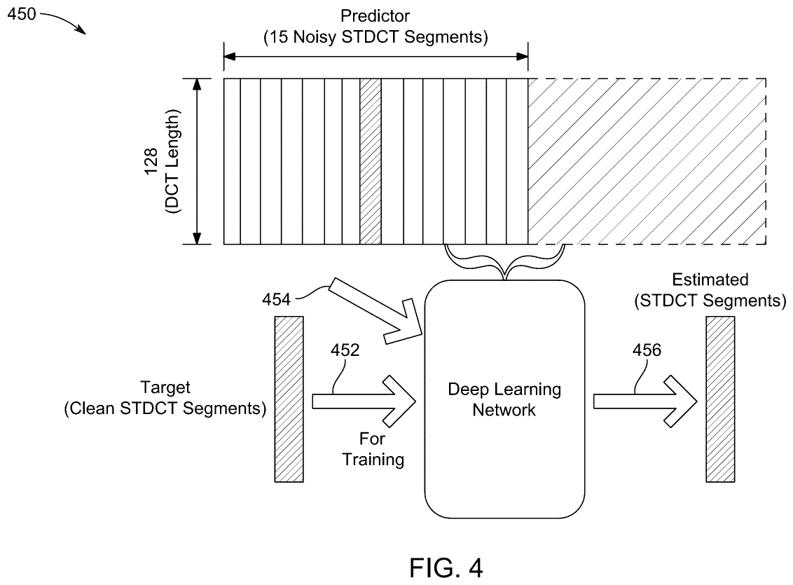

An exemplary schematic diagram of the deep neural network 314 for denoising 150 is depicted in FIG. 4. FIG. 4 illustrates two inputs to the deep neural network 314. One of the input 352 is a target segment which is a clean STDCT segment, and another input 354 is a predictor which is 15 noisy STDCT segments (segments of the time-frequency domain representation of noise-contaminated waveform). The output 356 of the deep neural network 314 is an estimated STDCT segment which is a cleaned middle segment. The deep neural network 314 of the disclosure is configured as a cascade of convolutional layers with descending followed by ascending sizes based on autoencoders to learn a sparse representation of the data with regard to a defined objective.

An exemplary implementation of the deep neural network 314 is shown in FIG. 5. The deep neural network 314 shown in FIG. 5 includes 12 convolutional layers 502 followed by transposed convolutional layers 504 (the convolutional layers with ascending sizes). Each layer's dimension provides layer information in a form of “frequency bins×time points×channels”. A last layer and a second to last layer of the deep neural network 314 is a fully connected layer 506 and a convolutional layer 508, respectively. In an embodiment, the fully connected layer 506 is to ensure that the last layer size matches the desired output size. The convolutional layer 502 and the transposed convolutional layers 504 have filter sizes of 3×3 each, and number of filters can vary from 8 filters to 512 filters. The last convolutional layer (the second last layer of the network) has one filter with a size of 1×1. Each convolutional layer 502 and the transposed convolutional layer 504 is followed by a leaky rectified linear unit (also known as an activation function LeakyReLu) layer and a batch normalization (BN) layer excluding the convolutional layer 508 and the fully connected layer 506. An activation function LeakyRelu is defined as follows:

$$g ( x ) = \{ \begin{matrix}0.01 z & for z < 0 \\ z & for z \geq 0\end{matrix} . \qquad ( 5 )$$

where z is input to the activation layer.

Initially, the 2D input data is passed through the 3×3 convolutional layers 502 for downsampling and further passed through the transpose convolutional layers 504 for upsampling. The fully connected layer can include 128 neurons. A parameter used for the convolutional layers 502 is: a value of stride. The value of stride is set to 1 or 2 along both horizontal and vertical directions. When the stride equals 1, padding is added to make the output a same size as the input. If the stride is greater than 1, the output size is d(InputSize./Stride)e (downsampled), where InputSize is the input's height or width, and stride is the stride in that dimension. In some examples, same amount of padding is added to top and bottom, as well as to the left and right to the data. In some examples, extra padding is added to the bottom when the padding that is added vertically has an odd value. If the horizontal padding that is added has an odd value, the extra padding is added to the right.

In an embodiment, parameters used for transposed convolutional layers include: a value of stride set to either 1 or 2 depending on the upsampling required in the horizontal/vertical direction. The stride can be defined as how much the input is stretched. In an example, cropping (output size reduction) is applied so that the output size equals Input_{Size}·*Stride. In some examples, shortcut connections are used to improve the prediction performance and convergence of training. With shortcut connections, the signal feeding into a layer is also added to the output of a layer located higher up the stacks.

For training the deep neural network 314, the parameter agnation with gradient descent optimization using root mean is used such as: the biases. The biases can be set to zeros while the weights are set to square error. In an example, a mini-batch size is chosen to be 512 and initialized. The deep neural network 314 is trained and an initial learning rate is set to lr=0.001 with squared gradient decay factor β2=0.999, and ∈=10⁻⁸. In an exemplary implementation, the learning rate is reduced by a factor of 0.9 for every epoch. The training is terminated when validation loss does not decrease for more than 5 epochs. A loss function used to calculate the gradients is given as:

$$𝔼 ( ϕ ) = \frac{1}{128} {\sum }_{q = 1}^{128} {\frac{1}{2} [ t ( q ) - p ( q ) ]}^{2} \qquad ( 6 )$$

where p(q) and t(q) are the qth element of network prediction and target output, respectively, and φ represents the parameters of the deep neural network. The deep neural network 314 is trained based on the loss function. A regularization term is also added to the loss function E(φ) to reduce the overfitting problem, that is:

$${𝔼}_{r} ( ϕ ) = 𝔼 ( ϕ ) + \frac{λ}{2} {ww}^{T} . \qquad ( 7 )$$

In an example, a value of a regularization factor λ is chosen to be 0.00005.

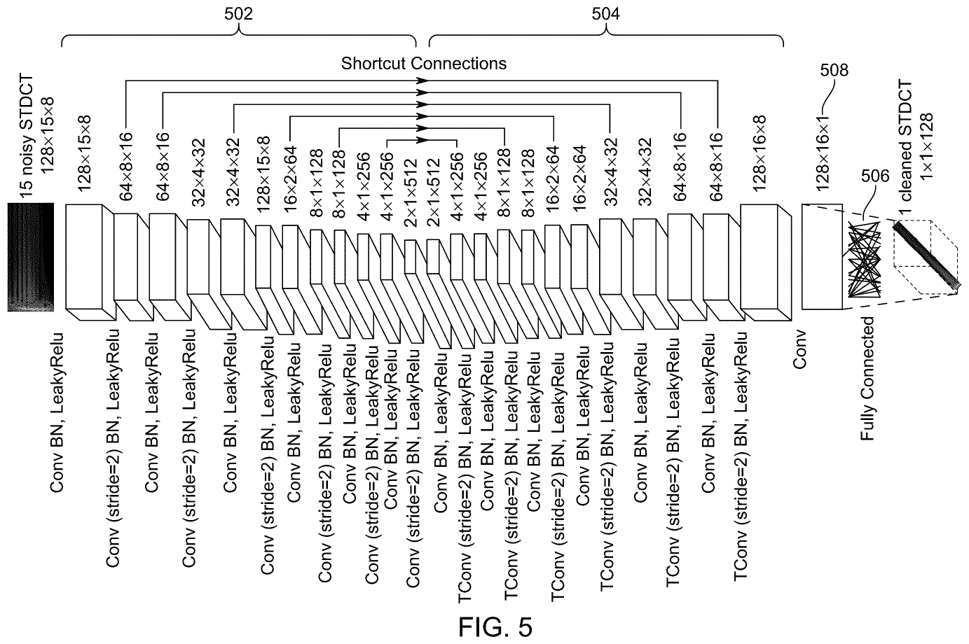

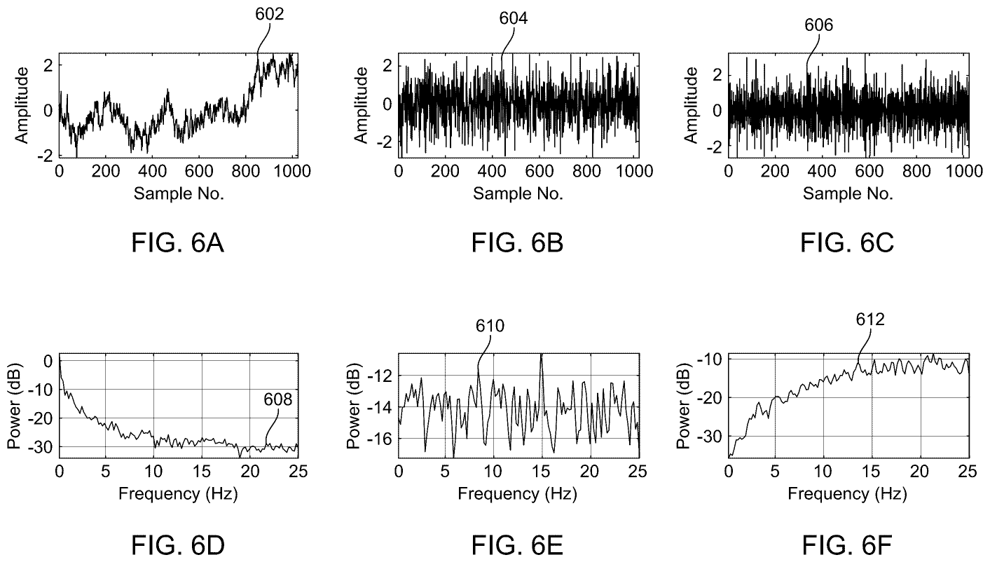

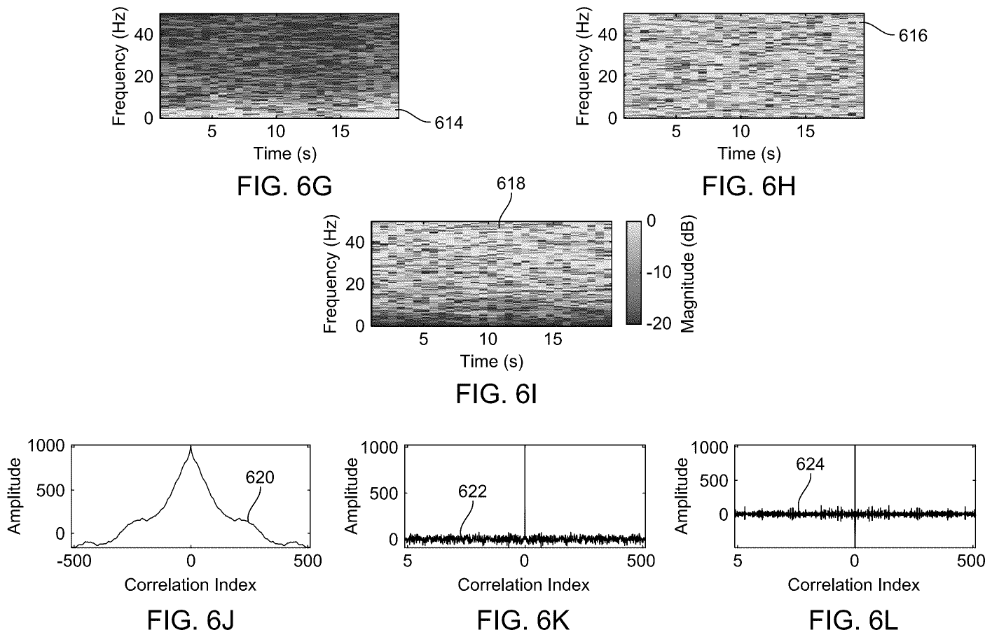

Training data set and its generalization is described now in detail. A data set for the training is generated using following wavelets: Biorthogonal (bior), Daubechies (db), Symlets (sym), Coiflets (coif), Meyer (meyr), Reverse biorthogonal (rbio), and Fejer-Korovkin (fk). These wavelets are obtained from Wavelet Toolbox™ (built by The MathWorks, Inc., Apple Hill Campus, 1 Apple Hill Drive, Natick, MA 01760-2098, USA). The dataset is contaminated with the noise signals. In an example, the noise signals are generated using fast fractional differences algorithm based on the Fourier technique. The fast fractional differences algorithm inputs two parameters fractional memory parameter (half of the spectral index) d and degree of correlation φ(=0.99). Various types of noise sequences are generated by varying the value of d over the range [−2, 2]. Noise realizations for d=−2, 0, 2 are shown in FIG. 6A-FIG. 6L together with respective properties in terms of spectrum, spectrogram and correlation plots. To elaborate, FIG. 6A shows a noise signal 602 with its corresponding spectrum (frequency vs. power plot 608) in FIG. 6D, spectrogram (frequency vs. Time plot 614) in FIG. 6G and its correlation (amplitude vs. correlation index 620) in FIG. 6J. The noise signal 602 corresponds to a brown noise with d=2. The spectrogram is a time-frequency representation of signal obtained using STDCT. Similarly, FIG. 6B shows a noise signal 604 with its corresponding spectrum (frequency vs. power plot 610) in FIG. 6E, spectrogram (frequency vs. Time plot 616) in FIG. 6H and its correlation (amplitude vs. correlation index 622) in FIG. 6K. The noise signal 604 corresponds to a white noise with d=0. FIG. 6C shows a noise signal 606 with its corresponding spectrum (frequency vs. power plot 610) in FIG. 6E, spectrogram (frequency vs. Time plot 618) in FIG. 6I, and its correlation (amplitude vs. correlation index 324) in FIG. 3L. The noise signal 306 corresponds to a purple noise with d=−2.

From FIG. 6A, it can be inferred that the noise signal 602 is highly correlated and contains mostly low frequencies as opposed to the noise signal 606 in FIG. 6C. The noise signal 604 in FIG. 6B has a flat spectrum like white noise. In some examples, noisy training data is generated by randomly selecting the wavelets and noise realizations. For training the deep neural network 314, 90% of the data is used as training data. The deep neural network 314 uses the remaining 10% of the data for validation. The processing unit 304 uses the STDCT to transform the noisy and noiseless seismic signal into the time-frequency domain representation. In an example, the input of the deep neural network is 15 columns (segments) of the 2D time-frequency matrices corresponding to the noisy time-series seismic signal, while the output is a single clean column of the 2D time-frequency matrices corresponding to the noiseless time-series seismic signal. In this way, the deep neural network 314 is trained to learn the time and frequency content of the seismic waveform. Thus, the deep neural network 314 is trained to predict 1 noiseless column using 15 noisy columns of the 2D time-frequency domain matrix. The processing unit 305 uses the validation data set to fine-tune hyperparameters of the disclosed signal denoising neural network apparatus and method. The validation enables the deep neural network 314 to detect and avoid overfitting.

### Examples and Experiments

The following examples are provided to illustrate further and to facilitate the understanding of the present disclosure. The signal denoising neural network apparatus and the method of the disclosure is tested, and the results obtained from the testing on unseen synthetic and field data sets are presented.

### Synthetic Dataset

A synthetic test set was used to analyze performance of the disclosed signal denoising neural network apparatus 212 and the method thereof, and visualize the denoising results. In the testing phase, wavelets that were not included in the training set were used. These wavelets included rbio5.5, fk14, sym15, bior6.8, bior3.7, db4, db6, db7 from the wavelet families. Noise signals were generated with various power spectral densities (PSD) using a power law model or 1/|ƒ|^{α} over its entire frequency range. The inverse frequency power α can take any value in the interval [−2, 2]. Examples include pink noise (α=1), brown (red or Brownian) noise α=2, white noise (α=0), blue or azure noise (α=−1), and purple or violet noise (α=−2). For the above noise, the noise generation techniques used were in contrast to the techniques used for generating noise in the training phase. Contrasting techniques were used to test the robustness of the deep neural network 314.

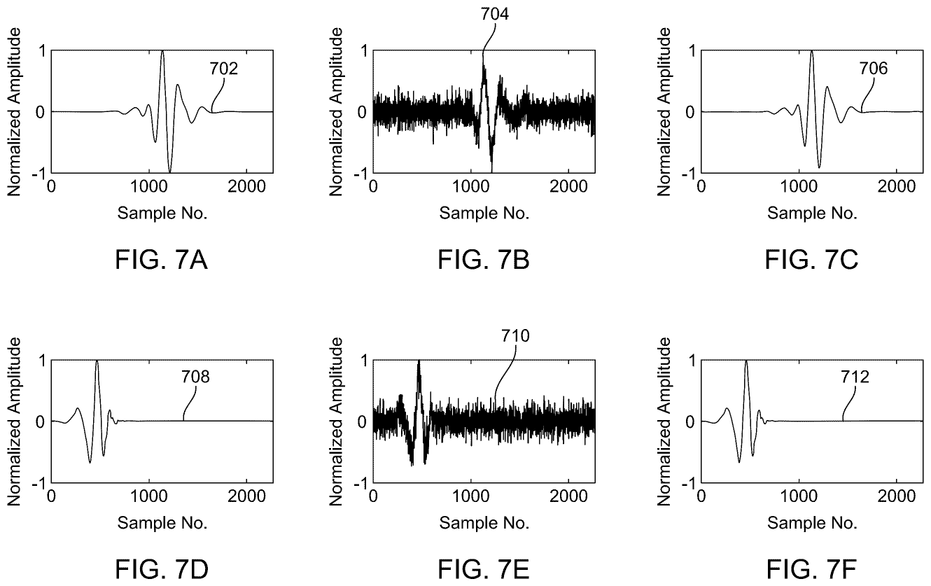

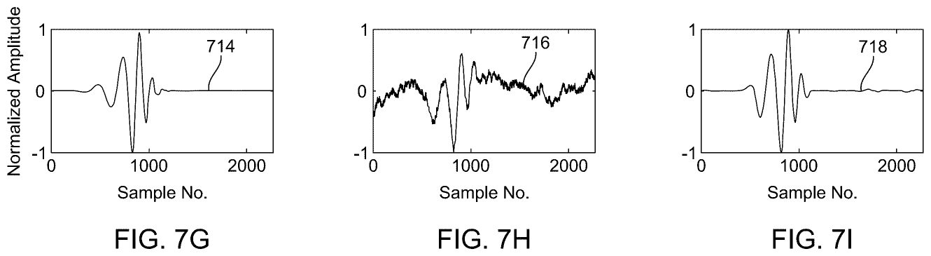

The result of applying the signal denoising neural network apparatus 100 and the method on the synthetic data under various noise realizations (correlated, uncorrelated, and with different frequency contents) is shown in FIG. 7A-FIG. 7I.

FIG. 7A-FIG. 7I demonstrates the ability of the disclosed signal denoising neural network apparatus 212 and the method, for accurately recovering the seismic signal from the test set. As shown in FIG. 7A, a seismic signal 702 is combined with a noise signal leading to a signal 704 shown in FIG. 7B. FIG. 7C shows the seismic signal 706 recovered using the signal denoising neural network apparatus 212 and the method. The recovered seismic signal 706 shows substantial or complete similarity with the original seismic signal 702. Similarly, FIG. 7D shows a seismic signal 408 which is combined with a noise signal leading to a signal 710 shown FIG. 7E. FIG. 7F shows a recovered seismic signal 712, which is substantially similar to the original seismic signal 708. Another example is shown in FIG. 7G-FIG. 7I where FIG. 7G shows a seismic signal 714 which is combined with a noise signal leading to a signal 716 shown FIG. 7H. FIG. 7I shows the recovered seismic signal 718, which is substantially similar to the original seismic signal 708, demonstrating the result of disclosed signal denoising neural network apparatus 212 and the method. FIG. 7A-FIG. 7I illustrates how the signal denoising neural network apparatus 212 and the method efficiently maintain amplitude characteristics, frequency components, and waveform shape while minimizing signal leakage.

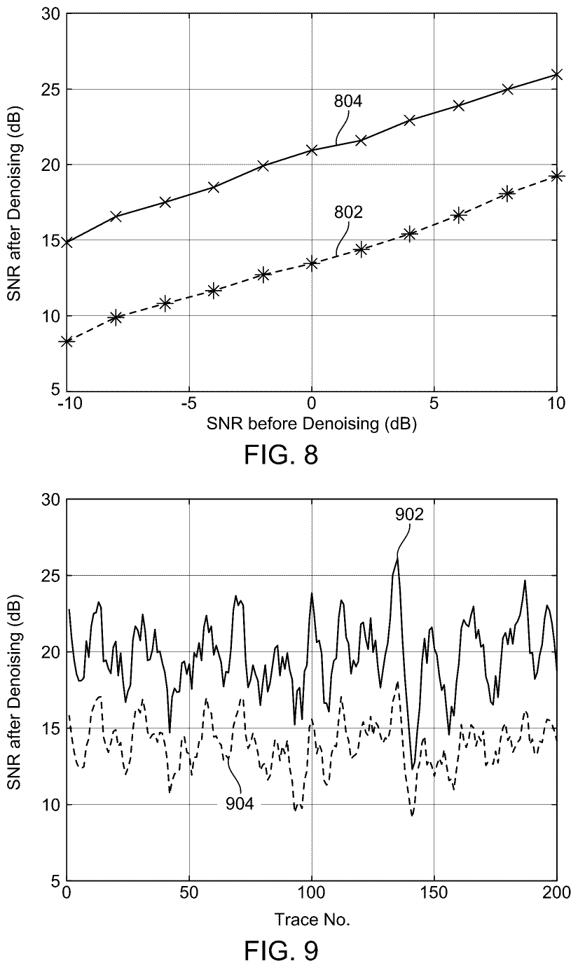

To compare the performance of the signal denoising neural network apparatus 212 and the method of the disclosure to that of the conventional deep neural network-based denoising approach by Zhu et al. (also referred to DeepDenoiser) was selected. Signal-to-noise ratio (SNR) enhancement before and after denoising is depicted in FIG. 8. FIG. 8 shows a signal 802 processed using the DeepDenoiser and a signal 804 processed by the current disclosure. The SNR is computed by averaging the respective SNR values across all traces. The use of the signal denoising neural network apparatus 212 and the method of the disclosure results in a significant improvement in performance, as demonstrated in FIG. 8. The performance is consistent over the range of SNR. In particular, more than 6 dB SNR enhancement is achieved when compared to DeepDenoiser, which performs the denoising task by predicting two adaptive thresholding masks. DeepDenoiser's performance is constrained by the thresholded mask. Hence, predicting the seismic source signature directly without using a mask improves the performance of the signal denoising neural network apparatus 212 and the method. Also, the DeepDenoiser approach is constrained by location (instant) of the seismic signal in the time-frequency plane. While producing the results of DeepDenoiser during the experiments, the location of the event was set in the middle of the time-frequency plane.

Since average SNR does not always give a good realistic view, trace-by-trace comparison was performed (shown in FIG. 9) to check the capabilities and the strength of the signal denoising neural network apparatus 212 and the method. Signal 902 represents SNR of signal traces obtained using the signal denoising neural network apparatus 212 and the method, while signal 904 represents SNR of signal traces obtained using the DeepDenoiser approach. FIG. 9 shows similar results, that is, the performance of signal denoising neural network apparatus 212 and the method is consistent with previous SNRs, and the SNR improvement is observed over all the traces. In other words, the performance of the signal denoising neural network apparatus 212 and the method is significantly better than the DeepDenoiser.

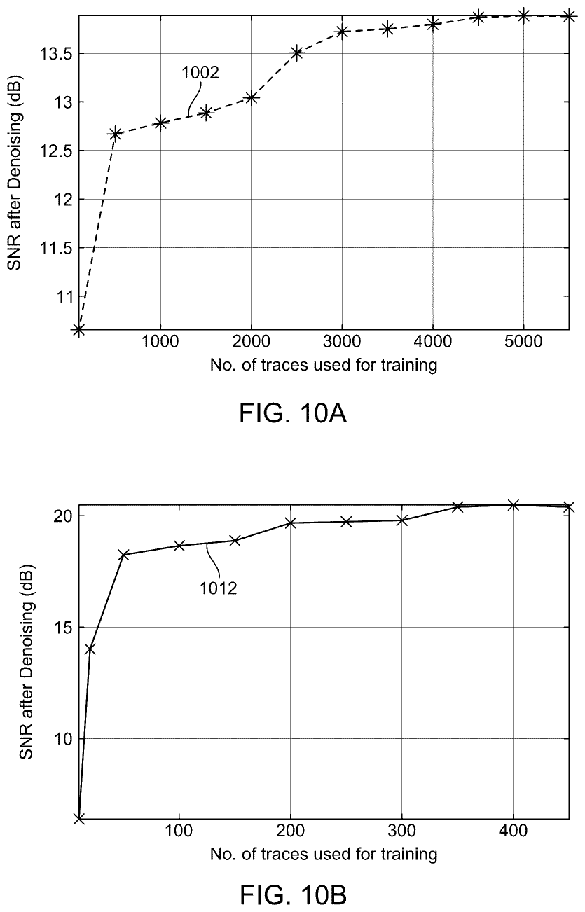

Next, the amount of training data required for current disclosure and the DeepDenoiser is compared in FIG. 10A-FIG. 10B. A trace in the training dataset consists of 2048 samples. In FIG. 10A, about 4500 traces were required to train the DeepDenoiser. On the other hand, in FIG. 10B, around 400 traces were required for training in the case of the signal denoising neural network apparatus 212 and the method. It is apparent that at least 10 times more sample data is needed for the DeepDenoiser in comparison with the disclosed signal denoising neural network apparatus 212 and the method. The signal denoising neural network apparatus and the method, requires far less training data with better performance in terms of SNR; compare 1002 and 1012. The reason being that the signal denoising neural network apparatus 212 and the method uses segments of the time-frequency representation as opposed to using the whole time-frequency plane.

### Field Dataset

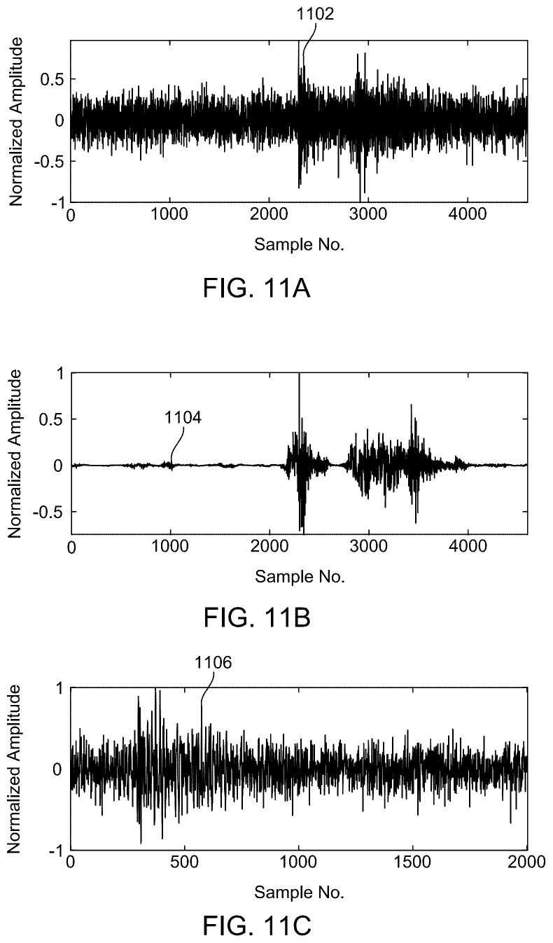

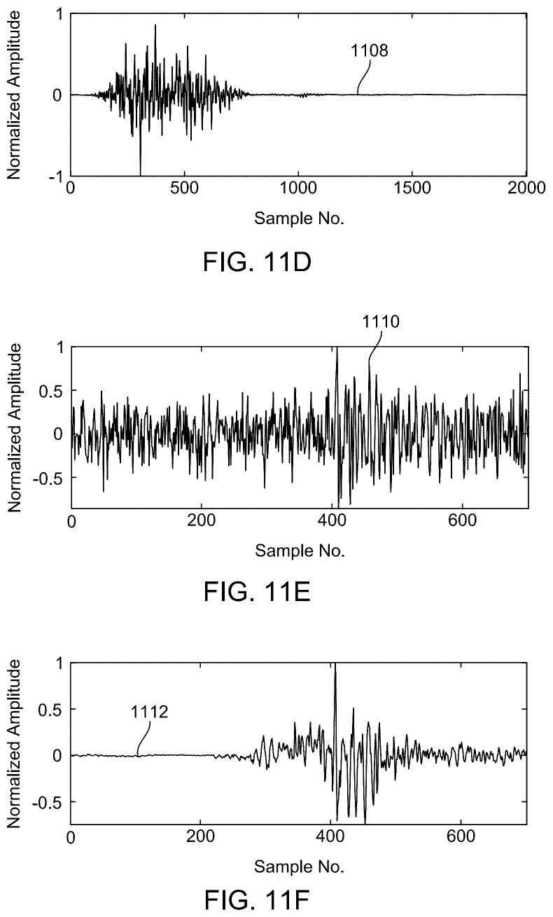

To further enhance the performance and generalization of signal denoising neural network apparatus 212 and the method, a synthetically generated seismic signal (with realistic parameters) was included in the training set together with previously defined wavelets. The noise is generated in a similar way as described above. The synthetic seismic signal is generated using known techniques. The seismic signal generation requires inputs like standard deviation (σ=1), dominant frequency (randomly selected from ƒ_{d}=[5, 25]), bandwidth, frequency vector for the Kanai-tajimi spectrum, amplitude value at 90% of the duration t₉₀=0.3, normalized duration when ground motion achieves peak (∈=0.4), and duration of the ground motion (randomly section from t=[1,10] sec). The time series is generated in two steps: first, a stationary process is created based on a Kanai-Tajimi spectrum, then an envelope function is used to transform this stationary time series into a non-stationary record. The Kanai-Tajimi is a crude representation of the behavior of the uppermost layer between the ground surface and the nearest bedrock, by lumping the stiffness, inertia and dissipative properties of the medium. Finally, the signal denoising neural network apparatus 212 and the method is applied to the field data sets. These field data sets are obtained from the Incorporated Research Institutions for Seismology (IRIS) and are shown in FIG. 11A-FIG. 11F. FIG. 11A, FIG. 11C and FIG. 11E are seismograms heavily contaminated by noise and thus have low SNR levels. The results 1104, 1108 and 1112 corresponding to the signals 1102, 1106 and 1110 demonstrates that the signal denoising neural network apparatus 212 and the method, successfully recovers seismic signals under extremely noisy conditions.

Although the deep neural network 314 is trained on synthetic data, the deep neural network 314 can denoise real seismograms. The signal denoising neural network apparatus 212 and the method can be applied directly for performing denoising real-life tasks that rely on undistorted clean seismic waveforms.

The signal denoising neural network apparatus 212 and the method of the disclosure is configured to learn a set of sparse features from time-frequency samples of noisy data with a goal to enhance seismic signals and attenuate noise. These features reflect the characteristics of a signal of interest more precisely, and, therefore, effectively denoise input signals. The signal denoising neural network apparatus 212 and the method automatically determines the signal information contained by each data point in the time-frequency plane without a need for thresholding. The signal denoising neural network apparatus learns a sparse representation of data by controlling a loss function using the segments of a time frequency representation. The results show that the signal denoising neural network apparatus 212 and the method can achieve effective and robust denoising performance even when the frequency contents of the signal and noise overlap. The signal denoising neural network apparatus 212 and the method denoising capabilities may extend beyond just random white noise, with promising results for a variety of correlated and uncorrelated noise as well as other non-seismic signals. The experiments performed indicate that the signal denoising neural network apparatus 212 and the method may substantially enhance the SNR while minimally affecting the underlying signal of interest. The signal denoising neural network apparatus 212 and the method may preserve seismic signal shape more robustly when compared with other denoising methods, even under extremely noisy environments. The signal denoising neural network apparatus 212 and the method are able to generalize to unseen data sets apart from the training set. In some embodiments, the signal denoising neural network apparatus 212 and the method may be tailored to work with a variety of signals (both seismic and non-seismic) and applications in other settings. Medical imaging, speech signal denoising, microseismic monitoring, fault detection, seismic imaging, preprocessing of ambient noise data, and test-ban treaty monitoring may be other potential applications of the signal denoising neural network apparatus 212 and the method framework. As described that the deep neural network 314 is trained exclusively using synthetic seismic data, negating the need for real data during the training phase. Experimental tests on synthetic and real data demonstrate the superiority and effectiveness of the signal denoising neural network apparatus 212 and the method compared to another state-of-the-art deep neural network-based denoising method.

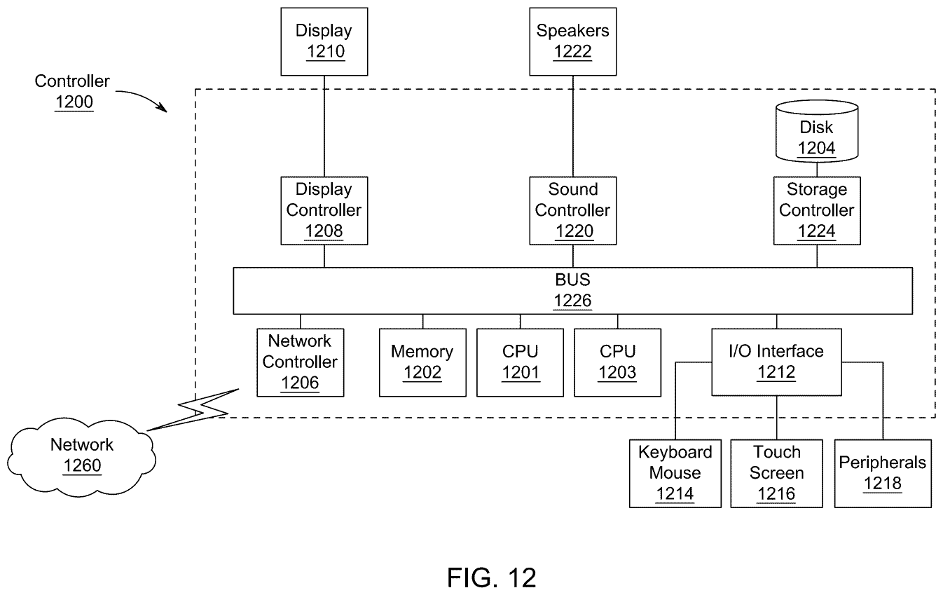

Next, further details of the hardware description of the computing environment of FIG. 3 according to exemplary embodiments is described with reference to FIG. 12. In FIG. 12, a controller 1200 is described is representative of system 212 of FIG. 3 in which the processing unit 304 is a computing device which includes a CPU 1201 which performs the processes described above/below. The process data and instructions can be stored in memory 1202. These processes and instructions can also be stored on a storage medium disk 1204 such as a hard drive (HDD) or portable storage medium or may be stored remotely.

Further, the embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, embodiments may be provided as a utility application, background daemon, or component of an operating system, or combination thereof, executing in conjunction with CPU 1201, 1203 and an operating system such as Microsoft Windows 7, UNIX, Solaris, LINUX, Apple MAC-OS and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of the ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general-purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

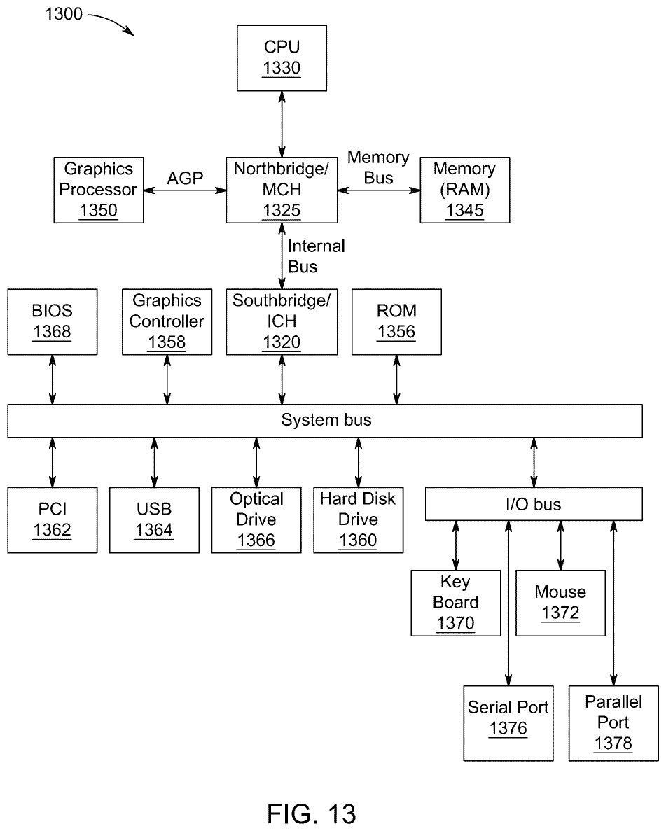

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system 1300 used within the computing system, according to exemplary aspects of the present disclosure. The data processing system 1300 is an example of a computer in which code or instructions implementing the processes of the illustrative aspects of the present disclosure may be located.

In FIG. 13, data processing system 1380 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1025. The NB/MCH 1325 also connects to the memory 1345 via a memory bus, and connects to the graphics processor 1350 via an accelerated graphics port (AGP). The NB/MCH 1025 also connects to the SB/ICH 1320 via an internal bus (e.g., a unified media interface or a direct media interface). The CPU Processing unit 1330 may contain one or more processors and even may be implemented using one or more heterogeneous processor systems.

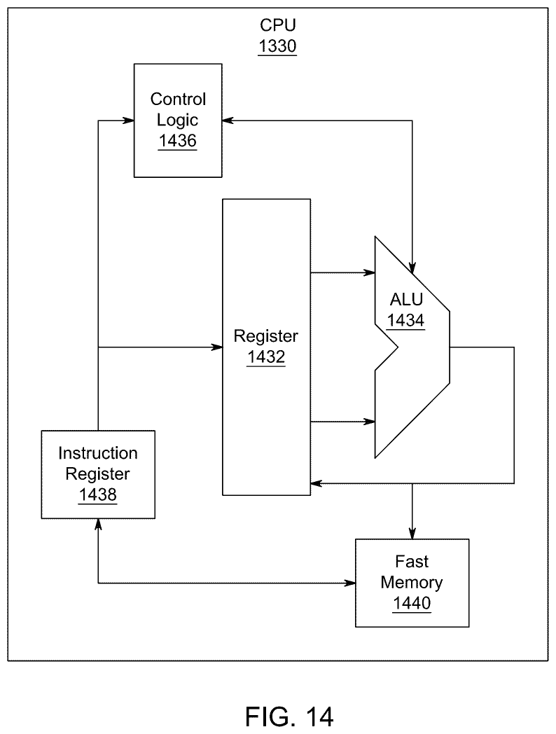

For example, FIG. 14 shows one aspects of the present disclosure of CPU 1330. In one aspects of the present disclosure, the instruction register 1438 retrieves instructions from the fast memory 1440. At least part of these instructions is fetched from the instruction register 1438 by the control logic 1436 and interpreted according to the instruction set architecture of the CPU 1330. Part of the instructions can also be directed to the register 1432. In one aspects of the present disclosure the instructions are decoded according to a hardwired method, and in another aspect of the present disclosure the instructions are decoded according to a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain aspects of the present disclosures, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1080 can include that the SB/ICH 1020 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1320 through a PCI bus 1362.

The PCI devices may include, for example, Ethernet adapters, add-in cards, and PC cards for notebook computers. The Hard disk drive 1360 and CD-ROM 1356 can use, for example, an integrated drive electronics (IDE) or serial advanced technology attachment (SATA) interface. In one aspect of the present disclosure the I/O bus can include a super I/O (SIO) device.

Further, the hard disk drive (HDD) 1060 and optical drive 1366 can also be coupled to the SB/ICH 1320 through a system bus. In one aspects of the present disclosure, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

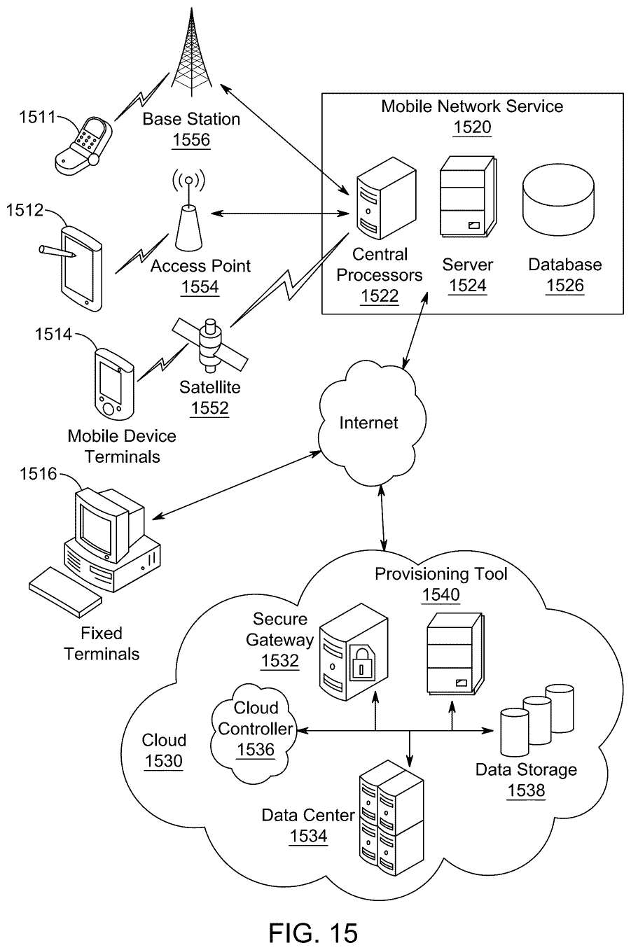

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 15, in addition to various human interface and communication devices (e.g., display monitors, smart phones, tablets, personal digital assistants (PDAs)). More specifically, FIG. 15 illustrates client devices including smart phone 1211, tablet 1512, mobile device terminal 1514 and fixed terminals 1516. These client devices may be commutatively coupled with a mobile network service 1520 via base station 1556, access point 1554, satellite 1552 or via an internet connection. Mobile network service 1520 may comprise central processors 1522, server 1524 and database 1526. Fixed terminals 1516 and mobile network service 1520 may be commutatively coupled via an internet connection to functions in cloud 1530 that may comprise security gateway 1532, data center 1534, cloud controller 1536, data storage 1538 and provisioning tool 1540. The network may be a private network, such as a LAN or WAN, or may be a public network, such as the Internet. Input to the system may be received via direct user input and received remotely either in real-time or as a batch process. Additionally, some aspects of the present disclosures may be performed on modules or hardware not identical to those described. Accordingly, other aspects of the present disclosures are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An apparatus for denoising a microseismic signal, comprising:
a seismic data recording network comprising a plurality of geophones each having a seismic data receiver and configured to record a plurality of microseismic waves as a signal trace received from a geological formation, wherein the plurality of geophones is communicatively coupled with a seismic data processor;
wherein the seismic data processor has a preprocessing stage to transform the recorded signal trace to a time-frequency representation as real number values; and
processing circuitry including program instructions to:
generate, by a learned deep neural network, a denoised signal from the time-frequency representation,
wherein the learned deep neural network is trained using a segment of noisy spectra and a clean spectra segment to learn a mapping function that generates a segment of the denoised microseismic signal.

2. The apparatus of claim 1, wherein the preprocessing stage receives the signal trace and applies a sequence of discrete cosine transforms (STDCT) on windowed sections, by sliding a window location across the entire recorded signal trace and applying DCT on each windowed section, to obtain N segments of a noisy spectra of the signal trace in time frequency domain.

3. The apparatus of claim 1, wherein the deep neural network is a deep convolutional neural network having a cascade of convolutional layers with descending followed by ascending sizes, where a last layer is a fully connected layer.

4. The apparatus of claim 1, wherein an input to the deep neural network is 15 noisy segments and the output is a cleaned middle segment.

5. The apparatus of claim 3, wherein the convolutional layers with ascending sizes are transposed convolutional layers.

6. The apparatus of claim 1, wherein the segment of noisy spectra for training includes a past noisy spectra, future noisy spectra, and current noisy spectra.

7. The apparatus of claim 1, wherein the deep neural network is trained based on a loss function of:
$$𝔼 ( ϕ ) = \frac{1}{128} {{\sum }_{q = 1}}^{128} {\frac{1}{2} [ t ( q ) - p ( q ) ]}^{2}$$
where p(q) and t(q) are the qth element of network prediction and target output, respectively, and φ represents parameters of the deep neural network.

8. The apparatus of claim 1, further comprising:
a seismic source configured to propagate an initial seismic wave at or above the geological formation,
wherein the plurality of geophones are configured to record a plurality of reflected microseismic waves as the signal trace reflected from the geological formation.

9. A non-transitory computer readable storage medium storing program instructions, which when executed by processing circuitry, performs a method comprising:
recording, by a seismic data recording network comprising a plurality of geophones, a plurality of microseismic waves as a signal trace received from a geological formation;
transforming, in a preprocessing stage, the recorded signal trace to a time-frequency representation as real number values; and
generating, by a learned deep neural network, a denoised signal from the time-frequency representation,
wherein the learned deep neural network is trained using a segment of noisy spectra and a clean spectra segment to learn a mapping function that generates a segment of denoised microseismic signal.

10. The storage medium of claim 9, further comprising:
receiving, by the preprocessing stage, the signal trace; and
applying a sequence of discrete cosine transforms (STDCT) on windowed sections, by sliding a window location across the entire recorded signal data and applying DCT on each windowed section, to obtain N segments of a noisy spectra of the signal trace in time frequency domain.

11. The storage medium of claim 9, further comprising:
inputting to the deep neural network 15 noisy segments, and
outputting a cleaned middle segment.

12. The storage medium of claim 9, further comprising:
training the deep neural network with the segment of noisy spectra that includes a past noisy spectra, future noisy spectra, and current noisy spectra.

13. The storage medium of claim 9, further comprising:
training the deep neural network based on a loss function of:
$$𝔼 ( ϕ ) = \frac{1}{128} {{\sum }_{q = 1}}^{128} {\frac{1}{2} [ t ( q ) - p ( q ) ]}^{2}$$
where p(q) and t(q) are the qth element of network prediction and target output, respectively, and φ represents parameters of the deep neural network.

14. The storage medium of claim 9, further comprising:
recording, by the plurality of geophones, a plurality of reflected microseismic waves as the signal trace reflected from the geological formation based on an initial seismic wave propagated by a seismic source at or above the geological formation.

15. A method of signal denoising, comprising:
recording, by a seismic data recording network comprising a plurality of geophones, a plurality of microseismic waves as a signal trace received from a geological formation;
transforming, in a preprocessing stage, the recorded signal trace to a time-frequency representation as real number values; and
generating, by a learned deep neural network, a denoised signal from the time-frequency representation,
wherein the learned deep neural network is trained using a segment of noisy spectra and a clean spectra segment to learn a mapping function that generates a segment of the denoised microseismic signal.

16. The method of claim 15, further comprising:
receiving, by the preprocessing stage, the signal trace; and
applying a sequence of discrete cosine transforms (STDCT) on windowed sections, by sliding a window location across the entire recorded signal data and applying DCT on each windowed section, to obtain N segments of a noisy spectra of the signal trace in time frequency domain.

17. The method of claim 15, further comprising:
inputting to the deep neural network 15 noisy segments, and
outputting a cleaned middle segment.

18. The method of claim 15, further comprising:
training the deep neural network with the segment of noisy spectra that includes a past noisy spectra, future noisy spectra, and current noisy spectra.

19. The method of claim 15, further comprising:
training the deep neural network based on a loss function of:
$$𝔼 ( ϕ ) = \frac{1}{128} {{\sum }_{q = 1}}^{128} {\frac{1}{2} [ t ( q ) - p ( q ) ]}^{2}$$
where p(q) and t(q) are the qth element of network prediction and target output, respectively, and φ represents parameters of the deep neural network.

20. The method of claim 15, further comprising:
recording, by the plurality of geophones, a plurality of reflected microseismic waves as the signal trace reflected from the geological formation based on an initial seismic wave propagated by a seismic source at or above the geological formation.
